(19) United States
(12) Patent Application Publication
(10) Pub. No.: US 2012/0079605 A1
(43) Pub. Date: Mar. 29, 2012

(54) Methods and Arrangements for Rendering Real-Time Media Services

(75) Inventors: Johan Bolin, Spanga (SE); Andreas Ljunggren, Vallingby (SE)

(73) Assignee: TELEFONAKTIEBOLAGET L M ERICSSON (PUBL), Stockholm (SE)

(21) Appl. No.: 13/375,538

(22) PCT Filed: Jun. 3, 2009
(86) PCT No.: PCT/SE09/50653

§ 371 Date: Dec. 1, 2011

(51) Int. Cl. G06F 15/16; G06F 21/24

(52) U.S. Cl. 726/27; 709/217

(57) ABSTRACT

The present invention relates to methods and arrangements for rendering a radio service. The radio service signal broadcasted to radio devices is divided into a plurality of different signals. The different signals may be retrieved via different channels and from different sources. Hence, the radio service signal is at least divided into a DJ signal containing a program guide and e.g. DRM keys, which may be retrieved from a media server e.g. hosted by a provider providing a radio channel and a payload signal, which may be retrieved from memory storage in device or a content server, with the payload (typically music). According to an embodiment of the present invention the radio signal comprises further a host signal. The host signal comprises voice content, commercial advertisements etc. The host signal may be retrieved from a content server e.g. hosted by the provider providing the radio channel. The radio service may be created by combining the DJ signal, the radio host signal and the payload signal, wherein the service is mastered by the DJ signal.

### TECHNICAL FIELD

The present invention relates to methods and arrangements for rendering real time media services such as broadcast radio and TV. In particular, the present invention relates to a terminal and media server wherein the terminal comprises a memory for storing content received from the media server, and to methods thereof.

### BACKGROUND

Radio is an established and adopted media service appreciated all over the world. Traditional radio is based on broadcasting in the ether. Recently radio broadcasting has reached the Internet. That implies that the content which traditionally has been broadcasted in the ether instead is transmitted as a streaming service over the Internet. Radio is a very useful linier media format to introduce new music and artists to the audience. Compared with pure on-demand services, radio is also appreciated since news and other information is interleaved with the music content. It is also a format that is easy to understand and consume for the user and an effective way to introduce new content, e.g. now music or TV-shows.

In addition, portable radio devices for playing music and video have become very popular, as memory have become cheap and content such as music has been digitalized. Today the memory capacity to store thousands of tracks with music is not more expensive than a couple of pressed records.

Broadband connections and the Internet have also enabled more interactive music and media services where the user can choose different music genres, play lists, artists and even the possibility to specify which songs to play. This means that the user can customize the music service to play the music and songs he requests.

The broadband connections to user devices have also facilitated content distribution networks where the users share content with each others using small content sharing servers and clients, e.g. Bit Torrents.

However, radio is basically the service where music is played according to a schedule and interleaved with spoken messages by a host or news reader, interviews etc. In advertisement funded radio, commercial messages are also interleaved in the program. Music and voice are often mixed together.

Consequently, radio as a service includes both music content as well as voice.

Interactive music services, also referred to as on demand radio is similar to the radio service, with the difference that the user has means to influence, to different degrees, the program guide.

In contrast to the case when the radio is broadcast in the ether, the bandwidth of the broadband connection, which is being used for the radio service when it is streamed over the Internet, constitutes a limited resource. It is therefore desired to utilize the broadband resources as efficiently as possible.

### SUMMARY

The idea of the present invention is to take advantage of that the user devices (e.g. portable media devices, mobile hand sets, home Hi-Fi and Set-Top boxes) have capabilities to store content. One characteristic for radio services but also for interactive radio is that most music will in a given time period be played multiple times. Radio services usually have a number of songs that are frequently played, and new and popular titles are typically played in multiple radio channels. For a service where the same content is transmitted several times in a day, the utilization of the broadband transmission will be greatly reduced if the same content only needs to be transmitted once instead of multiple times. If aggregating several channels the same track is often broadcasted several times per hour.

This means that they require an unnecessary high bandwidth. Voice needs approximately 1/10 of the bandwidth needed for music to provide good user experience. In web radio or TV (video) and/or interactive music services the problem is possibly even greater, as in difference from broadcast radio each user gets his unique stream of content.

According to a first aspect of the present invention a method in a user terminal for enabling consumption of livecast media is provided. In the method, a DJ signal comprising media content information and scheduling information how to schedule media content is received. Media content indicated in the scheduling information is requested and the requested media content in at least one content signal is downloaded. Further, the media content received in the content signal is cached and a service is composed wherein the service comprises the media content scheduled according to scheduling information of the DJ signal. Finally, the composed service is rendered.

According to a second aspect of the present invention a user terminal for enabling consumption of livecast media is provided. The user terminal comprises a DJ engine for receiving a DJ signal comprising media content information and scheduling information how to schedule media content. Further, a media cache for requesting media content indicated in the media content information and for downloading the requested media content in at least one content signal is provided. The media cache is also configured to store the media content received in the content signal and the DJ engine is further configured to compose a service comprising the media content scheduled according to the scheduling information of the DJ signal. The user terminal further comprises a media player for rendering the composed service.

According to a third aspect of the present invention a media server for enabling livecast media at a user terminal is provided. The media server comprises a transmitter for providing control information to a user terminal, wherein the control information is associated with livecast media. The control information comprises at least scheduling information on how to schedule media content to be cast live and media content information.

According to a fourth aspect of the present invention a method in a media server for enabling livecast media at a user terminal is provided. In the method, control information is provided to a user terminal. The control information is associated with livecast media and the control information comprises at least scheduling information how to schedule media content to be cast live and media content information.

An advantage with embodiments of the present invention is that they save bandwidth resources by using the device memory capacity to cache content such that the content does not need to be downloaded each time the content should be played out.

A further advantage with embodiments of the present invention is that it is possible to enable end-user radio or TV services and interactive radio services with own favourites without heavy traffic consumption.

A yet further advantage with embodiments of the present invention is that it is possible to provide higher music or video quality compared with broadcasted radio, since the music can be downloaded with higher quality e.g. during periods with low network utilization.

A yet further advantage with embodiments of the present invention is that it facilitates peer-to-peer/sharing principles and technologies (e.g. bit torrents) to exchange protected media and that it facilitates purchase of the downloaded tracks conveniently.

A yet further advantage is that it facilitates a content acquisition procedure (buying a licence) where the pay load does not need to be sent at the time the content is acquired. Instead only the licence key is sent, which is a far less data and can be sent as a short message.

### BRIEF DESCRIPTION OF THE DRAWINGS

FIG. 1 illustrates the terminal and the media server according to embodiments of the present invention.

FIG. 2 is a sequence diagram showing a method according to embodiments of the present invention.

FIGS. 3-5 illustrate schematically embodiments of the present invention.

FIG. 6 illustrates a DJ signal according to embodiments of the present invention.

FIG. 7 is a sequence diagram showing a method according to embodiments of the present invention.

### DETAILED DESCRIPTION

The present invention will be described more fully hereinafter with reference to the accompanying drawings, in which preferred embodiments of the invention are shown. The invention may, however, be embodied in many different forms and should not be construed as limited to the embodiments set forth herein; rather, these embodiments are provided so that this disclosure will be thorough and complete, and will fully convey the scope of the invention to those skilled in the art. In the drawings, like reference signs refer to like elements.

Moreover, those skilled in the art will appreciate that the means and functions explained herein below may be implemented using software functioning in conjunction with a programmed microprocessor or general purpose computer, and/or using an application specific integrated circuit (ASIC). It will also be appreciated that while the current invention is primarily described in the form of methods and devices, the invention may also be embodied in a computer program product as well as a system comprising a computer processor and a memory coupled to the processor, wherein the memory is encoded with one or more programs that may perform the functions disclosed herein.

In the embodiments of the present invention, the radio service signal broadcasted to radio devices is divided into a plurality of different signals.

The different signals may be retrieved via different channels and from different sources. Hence, the radio service signal is at least divided into:
1. A DJ signal containing a program guide and e.g. DRM keys, which may be retrieved from a media server e.g. hosted by a provider providing a radio channel.
2. A payload signal, which may be retrieved from memory storage in device or a content server, with the content (typically music or video).

According to an embodiment of the present invention the radio signal comprises further a host signal. The host signal comprises voice content, commercial advertisements etc. The host signal may be retrieved from a content server e.g. hosted by the provider providing the radio channel.

According to an embodiment of the present invention, the radio service is created by combining the DJ signal, the radio host signal and the payload signal, wherein the service is mastered by the DJ signal. In addition, the radio device comprises mechanisms to acquire new payload, e.g. music, using download mechanisms as well as broadcast mechanisms.

The embodiments of the present invention utilize the fact that the different signals have different bandwidth requirements and that not all signals must be broadcasted in real-time. I.e., the DJ signal comprising the program guide may be downloaded in advance and when the program guide is received, the terminal is aware of which content that should be played out and of the timing. If the program guide content in the DJ signal is downloaded in advance (cached), a heart beat signal is needed to synchronize the time table in the device with the service time. This may also be needed if licenses are downloaded in advanced, they would typically have a time for when they are valid which is relative to the service time. This implies that the payload (e.g. music) which usually requires favorable bandwidth conditions, may be downloaded during the night, when the load of the IP networks is rather low. Moreover, music and other content may be downloaded with an improved quality if higher bandwidth resources can be used.

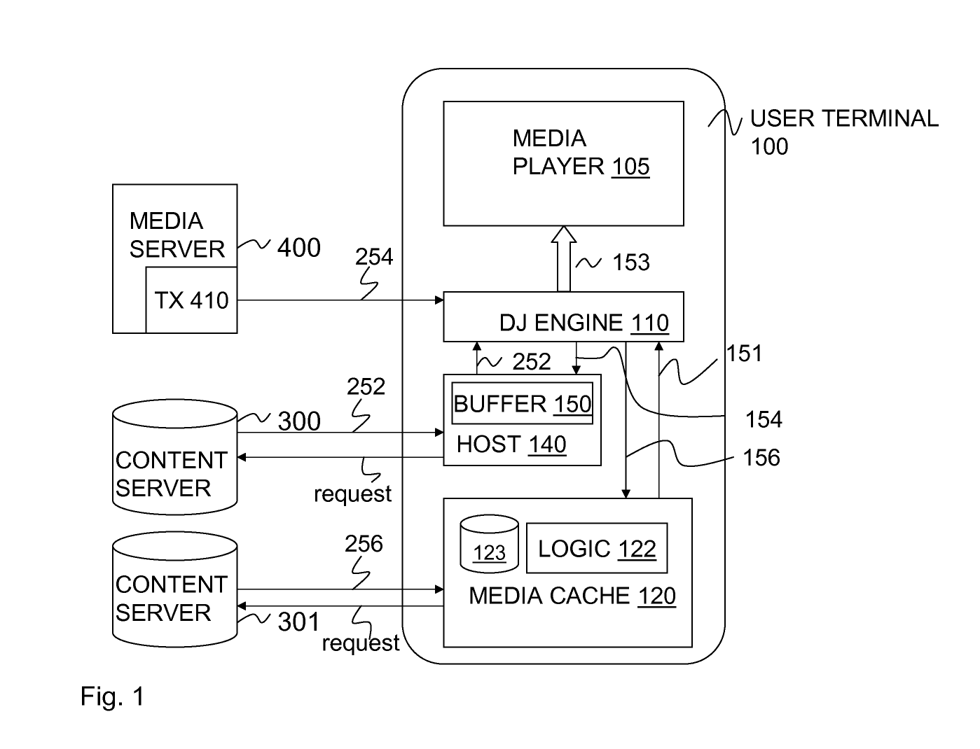

To enable the separation of the radio signal into the DJ signal, the radio host signal and the payload signal, the user device comprising the media player comprises further at least a DJ engine and a media cache. According to embodiments, the user terminal also comprises a host. The user terminal according to these embodiments is illustrated in FIG. 1.

FIG. 1 illustrates a user terminal 100 comprising a media player 105 and a media cache 120. Furthermore, a DJ engine 110 and a host 140 are provided in the user terminal 100.

The DJ engine 110 composes the radio service which is defined by the DJ signal 154. The DJ Signal 154 is the master of the service and may include information such as what content shall be played, when, how it shall be rendered, as well as DRM (Digital Rights Management) information needed to play it. The DJ Signal 154 may also include program guides for what will be played in the future. The DJ signal 154 may be retrieved by low bit rate broadcast from a media server 400 in real-time or downloaded in advance.

The host 140 is the component providing the radio host content, news and commercials. It should be noted that e.g. commercials and other content may also be retrieved from the media cache 120. The content of the host signal 252 is typically voice, which may be retrieved in real-time from a content server 300. This content server may be controlled by the provider of the radio service in a similar way as the media server 400. However, the host component 140 may contain a buffer 150, enabling the host signal to be semi-real-time and buffered while media is being played. The content server 300 from where the host signal is downloaded may be integrated with the media server 400.

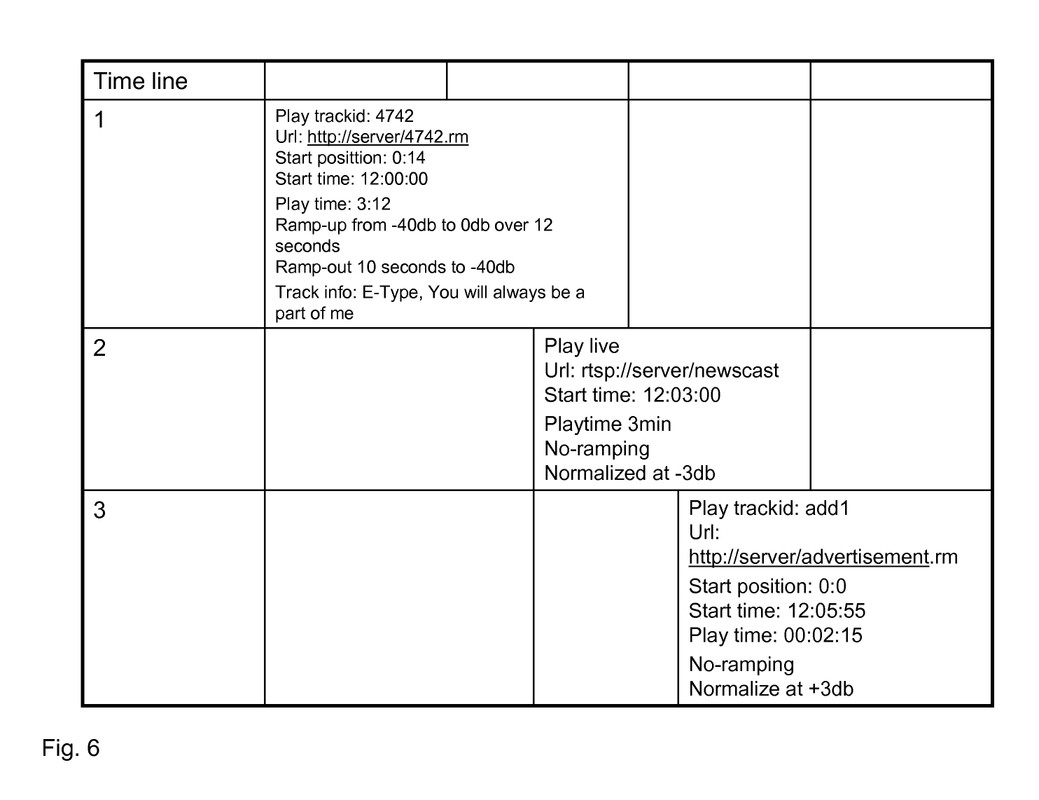

The media cache 120 is where the content (also referred to as media and payload) is stored and managed. The content is downloaded from a content server 301. Some content may be DRM protected which implies that the cache needs the DRM key from the DJ Signal to have its content playable. The content must be indexed and labeled correctly to be compliant with the DJ Engine and the DJ Signal. An example of the DJ signal is illustrated in FIG. 6.

The media cache 120 comprises a media cache manager logic 122. The Media cache manager maintains the data base 123 of the media cache with the content. This is performed according to user preferences, the program guide and also the IPR policies (e.g. if the content is owned by the user etc.) of the content.

If the program guide information of the DJ signal 154 indicates a certain content, but this content is not stored in the media cache 120, this media may be downloaded either immediately depending on configuration and network availability or at a time which is suitable for the network, e.g. during the night or other low activity periods. When and how the media is downloaded depends on user preferences such as bandwidth, cost etc.

Accordingly, the user terminal 100 according to one embodiment of the present invention comprises a DJ engine 110 for receiving a DJ signal 154 comprising media content information and scheduling information on how to schedule media content 256. The user terminal 100 comprises further a media cache 120. The media cache comprises a media cache manager logic 122 for requesting media content 154 indicated in the media content information and for downloading the requested media content 156 received in at least one content signal. The media cache 120 is further configured to store the media content 156 received in the content signal and the DJ engine 110 is further configured to compose a service 153 comprising the media content 151 scheduled according to the scheduling information of the DJ signal 254. Moreover the user terminal 100 further comprises a media player 105 for rendering the composed service 153.

The DJ Engine also manages the synchronization of the service rendering and the service heart beat, which may be a part of the DJ Signal.

If the media supposed to be played according to the program guide is not available neither from the media cache 120 of the user terminal 100 nor as a stream from the network, the DJ engine 110 may have the possibility to play another content file with similar length and/or stile etc. to provide best possible user experience.

In addition, a host 140 may be provided in the user terminal 100. The host 140 is configured to request content from a content server 300 according to the information of the DJ signal 154. The requested content is received in a host signal 252 which is forward to the DJ engine 110 that composes the radio service by the host signal and the media 151 from the media cache.

The host signal 252 may also be buffered in a buffer 150 at the host 140 such that the host signal can be downloaded semi real-time from the content server 300.

The media cache 120 comprises a database 123 for storing the content and a logic unit 122 for managing the content. The logic unit may send a content management instruction signal instructing the media cache to acquire new content or to disband content.

The content/media in the data base 123 is typically encoded and requires certificates in the DJ Signal to be played. However, the content/media may also be unprotected, e.g. content that is either imported to the device from CD:s or content that the user has bought in on-line music stores.

The user terminal 100 may also comprise suitable means such that the user can get a long term certificate for the content, e.g. by buying it or getting it in a campaign etc. There are a couple of alternatives for how this is provided. The content might be completely decoded, meaning that it can be moved to other services or devices. Alternatively, the content remains encoded with an end-time or open ended certificate which is stored in the service index function, implying that the content can be played without requiring a DJ signal from the network. This function requires a mechanism where the user can get the certificate, according to terms in an agreement, which is applied to the content. Such feature typically also includes the means for charging for the content or a coupon/voucher manager handling the charging.

Thus, the media server 400 is provided for enabling livecast media at the user terminal. The media server 400 comprises a transmitter TX 410 for providing control information to a user terminal, wherein the control information is associated with livecast media. The provided control information comprises at least scheduling information on how to schedule media content to be cast live and media content information.

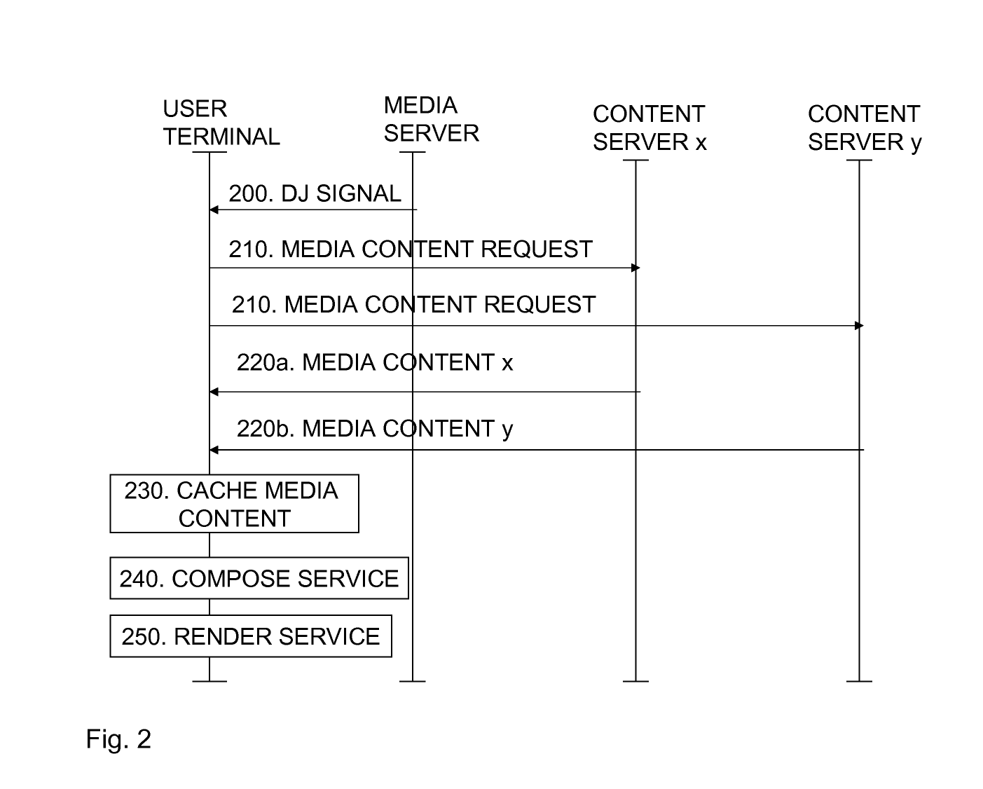

The methods carried out in the user terminal and the media server, respectively, are illustrated in the sequence diagram of FIG. 2. In step 200, a DJ signal comprising media content information and scheduling information on how to schedule media content is sent from the media server to the DJ engine of the user terminal. Media content which is indicated in the scheduling information is requested 210, depending on content type (server x or server y). The requested media content is downloaded 220a, 220b in at least one content signal, and the media content received in the content signal is stored 230 in a database of the media cache. The media content may be downloaded from different content servers as illustrated in FIG. 2. Further, a service comprising the media content scheduled according to scheduling information of the DJ signal is composed 240, and the composed service is rendered 250.

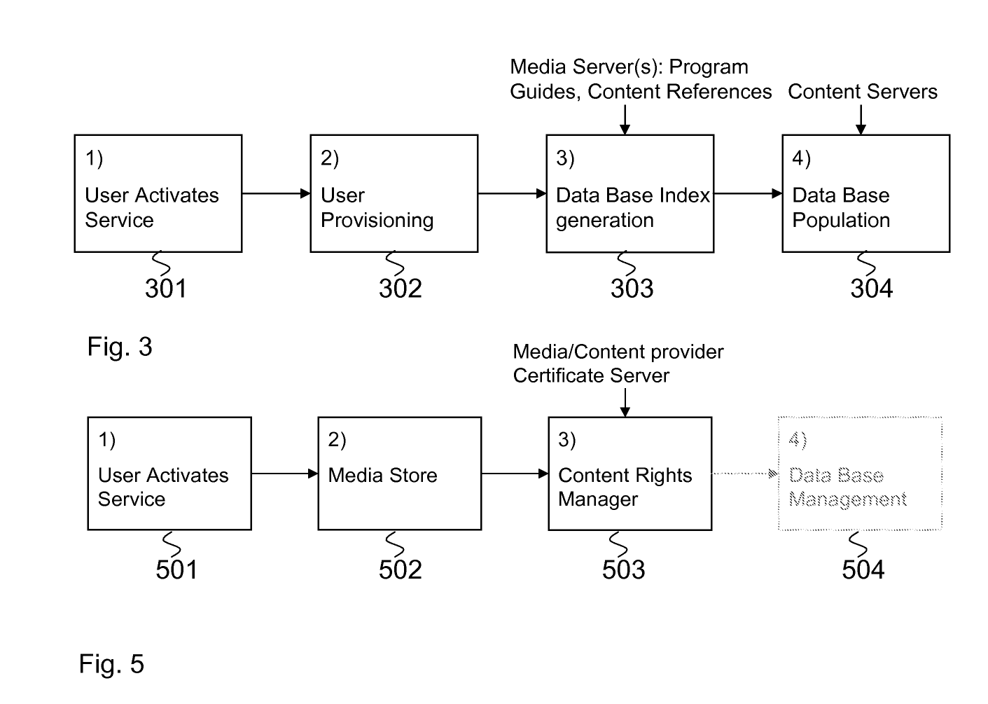

Turning now to FIG. 3 showing a function diagram of service activation and initial provisioning.

In step 301 of FIG. 3, the user activates the radio service. This step may include installing an application, e.g. a radio or TV application.

In step 302 the user makes an initial provisioning, where radio stations, lists of music, artists, music style etc. are provisioned. The user may also provision other data such as credit card numbers, mail addresses etc. that might be needed.

Based on the provisioned information of radio stations, favourite music etc., an index is created in step 303 with the content that shall be cached in the data base of the media cache. The information, e.g. information retrieved from the DJ signal but could also be retrieved using other sources and then merged in a database manager, from the media server also includes references to where the content can be acquired, both as downloading but also if/where it is available from broadcast (using e.g. MBMS). The media servers may also be content distribution networks and content sharing networks (e.g. bit torrents).

In step 304, actions are taken to populate the data base. This may be performed according to preferences or instructions such as “only download when in WiFi hot spots”, “download from broadcast” or other types of instructions.

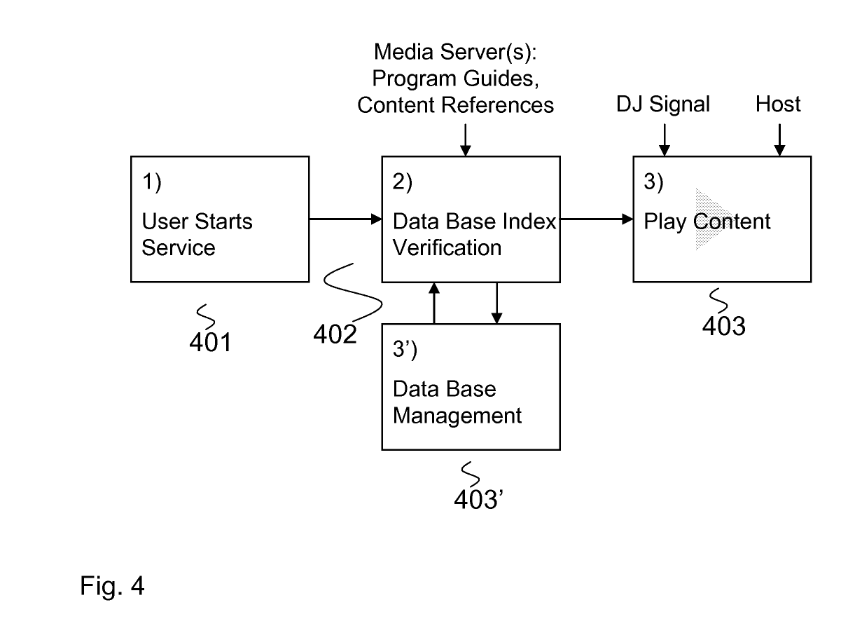

Turning now to FIG. 4 showing a function diagram of a service execution.

In step 401, the user starts the radio application. The radio channel, play list etc. may be selected or started automatically.

In step 402, the index of the content in the cache is updated, typically prioritizing the currently played channel/list. The index is analyzed and it is determined if the requested content is stored in the media cache. If the required content is not stored in the media cache, then the database management function (i.e. the logic unit of the media cache) is instructed to take actions if needed, e.g. downloading the content from a content server.

The user terminal renders the content according to the DJ signal in step 403. The media content, primarily retrieved from the local media cache but possibly complemented by streams if not available, and the host signal are mixed according to instructions in the DJ signal. The DJ signal may also include the temporary certificates needed to play the encoded content.

As a background process, the data base of the media cache is managed with updates in step 403′, disbanding of content etc. using the provisioned information and the program guides of the DJ signal.

Further, FIG. 5 is a function diagram illustrating the scenario when a long term certificate is acquired.

In step 501, the user starts the radio service.

In step 502, the user selects media store/“Buy” option, accepts the terms (e.g. payment).

In step 503, the content provider/aggregator provides a certificate according to the terms of an agreement (time period etc.) The aggregator aggregates content from several sources (providers) and provides it to other parties as “one customer interface”.

If the terms state that the media shall be decoded to an open format, e.g. MP3 or other, decoding is performed in step 504. The media file is updated/replaced as well as the database index.

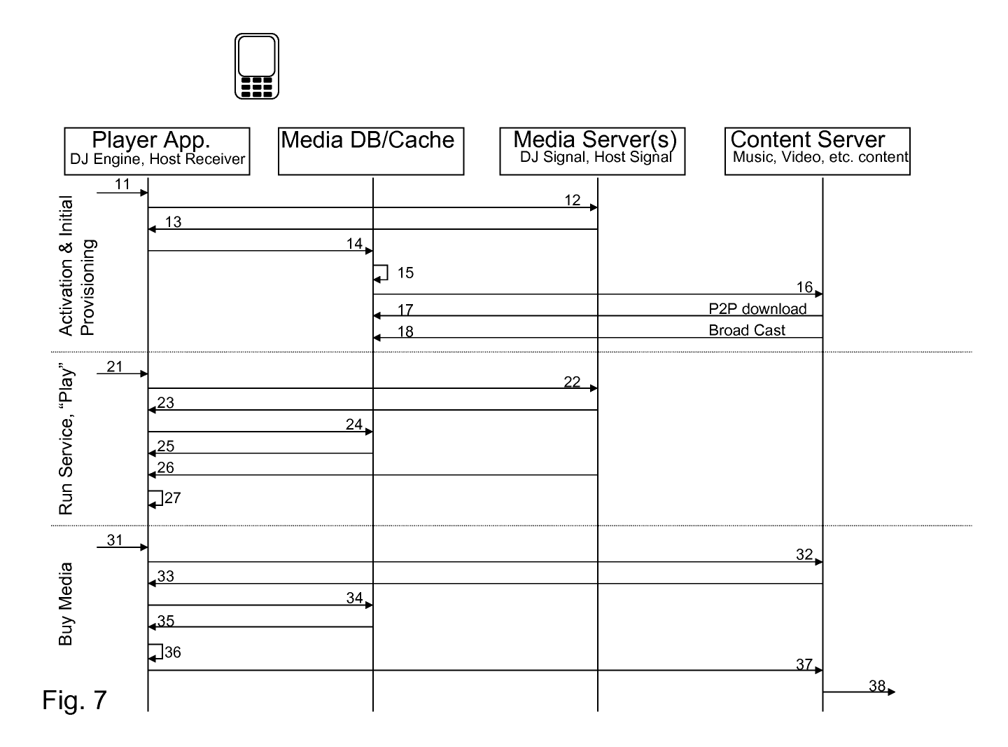

To further exemplify embodiments of the present invention a scenario is described in conjunction with FIG. 7.

The player application of FIG. 7 is the client application in the user device that manages the service. The player application corresponds to the DJ engine and the host described above. The player application according to this example includes user provisioning features where user preferences are managed.

The database of the media cache is a memory/disc with a local data base with content having IPR encoded formats or open formats. The media database/cache also has a register function with index and information of all content, and a database manager application managing the content according to instructions (e.g. from the DJ signal, history file) from the player application and user preferences.

The media server(s) is (are) the servers providing the radio service. In this example the host providing the host signal is integrated within one of the media server(s). Thus, the media server(s) basically provide(s) the DJ signal with the program guide and mixing instructions as well as the host signal.

The content server(s) may be servers or distribution networks where the content is available. These servers are typically controlled or operated in agreement with the IPR owner to manage certificates and charging thereof.

Step 11. The service/application is started

Step 12. The session is initiation

Step 13. Available radio channels, lists, artists, specific media etc are provided to the player application in the DJ signal and in the host signal.

Step 14. Radio channels, lists, artists, specific media selected by the user, e.g. by typed in a text field or selected from a list, are sent to the media cache to be stored.

Step 15. The content is indexed, based on specified content, programme guides of selected channels in combination with preferences and settings (user, device and network).

Step 16. A connection is established to content servers(s) (including “torrents”) and/or broadcast signals tuned in to e.g. Internet broadcast servers, mobile MBMS, etc. in order to download content specified in the DJ signal

Step 17. Content (e.g. IPR protected content) is downloaded, typically peer-to-peer (P2P), initiated from content server(s) or distribution/sharing networks.

Step 18. Broadcast “channels” are tuned in and the content is retrieved.

It should be noted that steps 16-18 typically run continuously in the background whenever the radio service is active, i.e. also in “Play” mode.

Step 21. The “Media Player” and the content service (e.g. radio service on-demand music etc.) are started.

Step 22. The session is established towards the media server.

Step 23. The DJ signal with temporary certificates is provided to client and the host signal is initiated. The certificates may alternatively be provided in step 26.

Step 24. The content indicated in the DJ signal is requested from the media cache.

Step 25. Encoded content is provided to the player application. However, the content may be non-encoded if the user has a long term certificate or if it is permanently decoded.

Step 26. The host signal is received while the DJ signal is being continuously read.

Step 27. The content and the host signal are decoded, rendered and mixed according to the information of the DJ Signal.

Step 31. The user selects a “Buy content” option in the player application, with selected content and requested terms and conditions.

Step 32. A certificate is requested from the content server. It should be noted that the content server already may, in a previous step, be provided with a credit check to check the users credit record.

Step 33. The certificate is provided to the player application.

Step 34. The content is requested from the media cache.

Step 35. The content is loaded to the player application.

Step 36. The certificate is applied on the content.

Step 37. The content server is notified if the certificate is successfully applied or not.

Step 38. Charging is performed and charging records are updated accordingly.

The present invention is not limited to the above-described preferred embodiments. Various alternatives, modifications and equivalents may be used. Therefore, the above embodiments should not be taken as limiting the scope of the invention, which is defined by the appending claims.

1-17. (canceled)

18. A method in a user terminal for enabling consumption of livecast media, the method comprising:
receiving a DJ signal comprising media content information and scheduling information how to schedule media content;
requesting media content indicated in the scheduling information;
downloading the requested media content in at least one content signal;
caching the media content in the content signal;
composing a service comprising the media content scheduled according to the scheduling information of the DJ signal; and
rendering the composed service.

19. The method according to claim 18, wherein the media content is Digital Rights Management (DRM) protected and the DJ signal further comprises DRM keys to unlock the media content.

20. The method according to claim 18, wherein the media content comprises media content to be rendered real-time or semi real-time.

21. The method according to claim 20, wherein the media content comprises at least one of voice, news, music, and commercials.

22. The method according to claim 18, wherein the media content information of the DJ signal comprises an address to a content server to which the media content is requested and synchronization information.

23. The method according to claim 18, wherein the media content is downloaded according to user preferences.

24. A user terminal for enabling consumption of livecast media, the user terminal comprising:
a DJ engine configured to receive a DJ signal comprising media content information and scheduling information regarding how to schedule media content;
a media cache configured to request media content indicated in the scheduling information and for downloading the requested media content in at least one content signal;
wherein the media cache is further configured to store the media content in the content signal;
wherein the DJ engine is further configured to compose a service comprising the media content scheduled according to the scheduling information of the DJ signal; and
a media player configured to render the composed service.

25. The user terminal according to claim 24, wherein the received media content is Digital Rights Management (DRM) protected and the DJ signal further comprises DRM keys to unlock the protected media content.

26. The user terminal according to claim 24, wherein the user terminal comprises a host configured to receive media content to be rendered real-time or semi real-time.

27. The user terminal according to claim 26, wherein the user terminal further comprises a buffer for buffering the media content to be rendered in semi real-time.

28. The user terminal according to claim 24, wherein the media cache is further configured to download the media content according to user preferences.

29. A media server for enabling livecast media at a user terminal, the media server comprising:
a transmitter configured to provide control information to a user terminal;
wherein the control information is associated with livecast media, and the control information comprises at least scheduling information regarding how to schedule media content to be cast live and media content information.

30. The media server according to claim 29, wherein the control information comprises Digital Rights Management (DRM) keys.

31. The media server according to claim 29, wherein the transmitter is configured to transmit a host signal comprising content associated with at least one of voice, news, and commercials.

32. A method in a media server for enabling livecast media at a user terminal, the method comprising:
providing control information to a user terminal;
wherein the control information is associated with livecast media, and the control information comprises at least scheduling information regarding how to schedule media content to be cast live and media content information.

33. The method according to claim 32, wherein the control information comprises Digital Rights Management (DRM) keys.

34. The method according to claim 32, further comprising transmitting a host signal comprising content associated with at least one of voice, news, and commercials.
